(19) United States
(12) Patent Application Publication
(10) Pub. No.: US 2012/0224014 A1
(43) Pub. Date: Sep. 6, 2012

(54) LABEL PRINTING DEVICE AND LABEL PRINTING METHOD

(75) Inventor: Akio Katsumata, Shizuoka (JP)

(73) Assignee: TOSHIBA TEC KABUSHIKI KAISHA, Tokyo (JP)

(21) Appl. No.: 13/410,638

(22) Filed: Mar. 2, 2012

(30) Foreign Application Priority Data
Mar. 3, 2011 (JP) 2011-46916

(51) Int. Cl. B41J 2/365

(52) U.S. Cl. 347/194

(57) ABSTRACT

According to one embodiment, a label printing device includes an image rendering unit configured to render a label image on a recording medium. The label printing device further includes a control unit configured to set an operation mode to one of a first operation mode, in which printing is performed while keeping a print speed constant, and a second operation mode, in which printing is performed while keeping a print concentration constant, and further configured to control the image rendering unit to render the label image in the selected mode.

### CROSS-REFERENCE TO RELATED APPLICATION

This application is based upon and claims the benefit of priority from Japanese Patent Application No. 2011-046916, filed on Mar. 3, 2011, the entire contents of which are incorporated herein by reference.

### FIELD

Embodiments described herein relate generally to a label printing device and a label printing method for printing a label.

### BACKGROUND

A label printing device forms an image on a recording medium based on a print image and a command received from an external information processing device using a communication function. A rechargeable battery can be installed in the label printing device to reduce weight while improving portability.

In such a label printing device, printing is performed under mutually-conflicting factors such as print speed, print concentration and power consumption. If the label printing device uses a battery as a power source and places an emphasis on portability, it is often the case that power consumption is automatically reduced to save battery life. As a result, depending on the type of printing, the print speed may become slower, thereby resulting in reduced throughput, or the print concentration may become too low.

### BRIEF DESCRIPTION OF THE DRAWINGS

FIG. 1 is a block diagram illustrating one example of a label printing device.

FIG. 2 is a schematic view showing one example of the exterior appearance of the label printing device.

FIG. 3 is a flowchart illustrating one example of a print process performed by the label printing device.

FIG. 4 is an explanatory view illustrating an operation mode selection screen of a personal computer connected to the label printing device.

FIG. 5 is an explanatory view illustrating a factor selection screen of a personal computer connected to the label printing device.

FIG. 6 is a flowchart illustrating another example of the print process performed by the label printing device.

### DETAILED DESCRIPTION

According to one embodiment, a label printing device includes an image rendering unit configured to render a label image on a recording medium. The label printing device further includes a control unit configured to control the image rendering unit to render the label image in one of a first operation mode, in which printing is performed while keeping a print speed constant, and a second operation mode, in which printing is performed while keeping a print concentration constant.

Certain embodiments will now be described in detail with reference to the accompanying drawings.

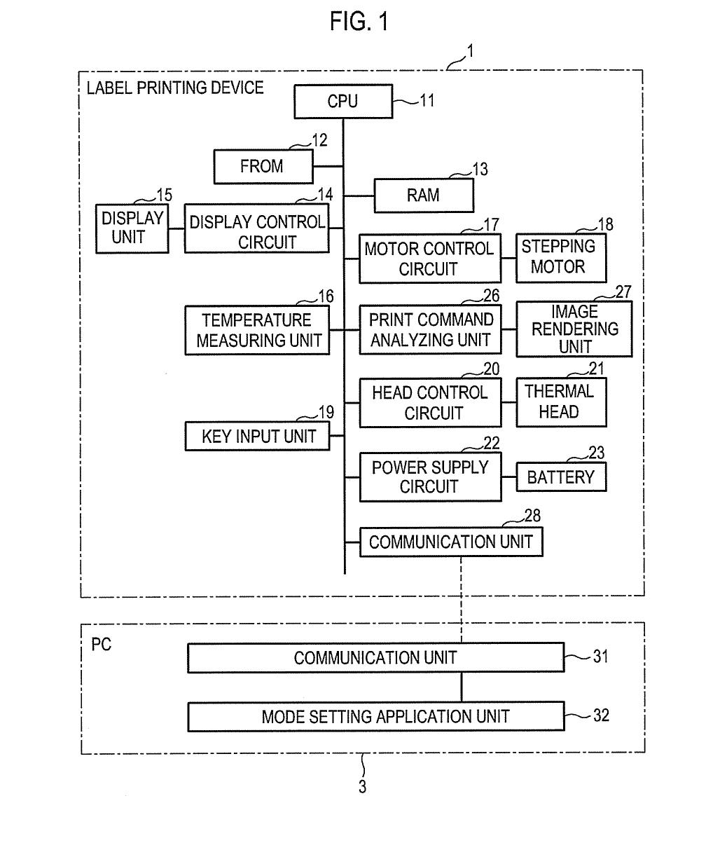

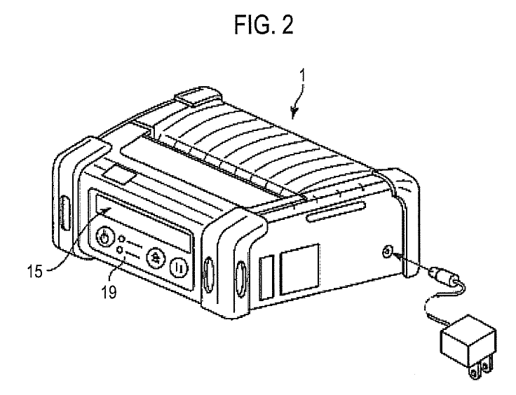

FIG. 1 is a block diagram illustrating one example of a label printing device according to an embodiment. FIG. 2 is a schematic view showing one example of the exterior appearance of the label printing device.

Referring to FIG. 1, the label printing device 1 is connected to a personal computer (PC) 3 through a network such as a wireless LAN or an infrared communication network. The label printing device 1 includes a CPU 11 controlling the entire operation of the label printing device 1 and serving as a history information management unit. The label printing device 1 further includes a FROM (Flash Read Only Memory) 12 connected to the CPU 11 and a RAM (Random Access Memory) 13 configured to store management data indicated by a barcode and a print image corresponding to the management data.

The label printing device 1 further includes a display control circuit 14, and a display unit 15 controlled by the display control circuit 14 and configured to display operation information and label information; a temperature measuring unit 16 configured to detect the internal temperature of the label printing device 1; a motor control circuit 17, and a stepping motor 18, whose operation is controlled by the motor control circuit 17; a key input unit 19, through which operation information and other information are inputted by a user; a head control circuit 20 configured to control printing a label image on a medium such as a label, and a thermal head 21 controlled by the head control circuit 20 and configured to perform printing on the medium; a power supply circuit 22 provided to supply electric power to the respective parts or units of the label printing device 1, and a battery 23 provided to feed electric power to the power supply circuit 22; a print command analyzing unit 26, and an image rendering unit 27 configured to render an image on a recording medium based on a print command from the print command analyzing unit 26; and a communication unit 28 configured to send/receive data such as a print image to/from the personal computer 3 or a host computer through a wireless LAN or by way of infrared communication. The display control circuit 14, display unit 15, temperature measuring unit 16, motor control circuit 17, stepping motor 18, key input unit 19, head control circuit 20, thermal head 21, power supply circuit 22, battery 23, print command analyzing unit 26, image rendering unit 27 and communication unit 28 are connected to the CPU 11 through an internal data bus.

The label printing device 1 configured as above receives a print command from the personal computer 3 or the host computer, such that the thermal head 21 is operated based on the print command to print a label as described in detail below.

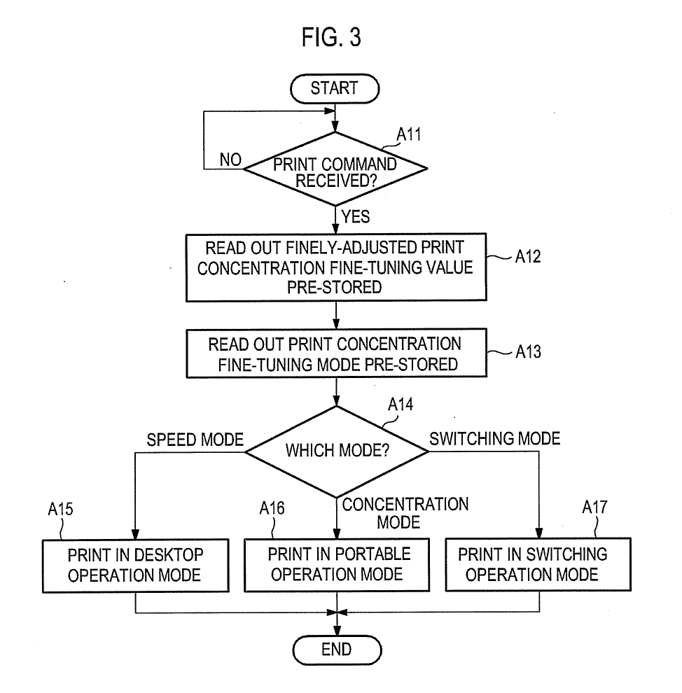

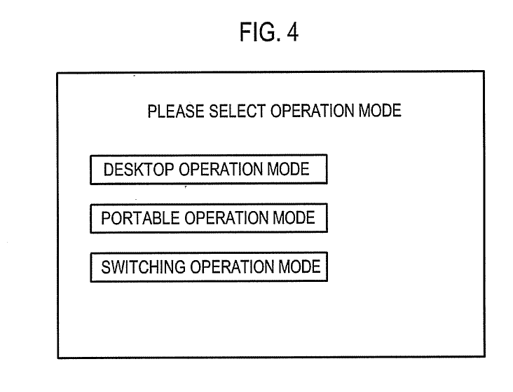

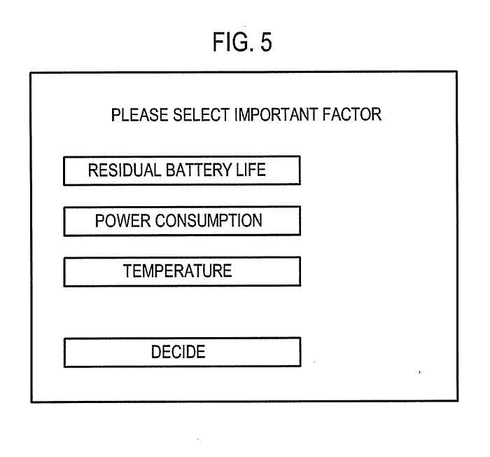

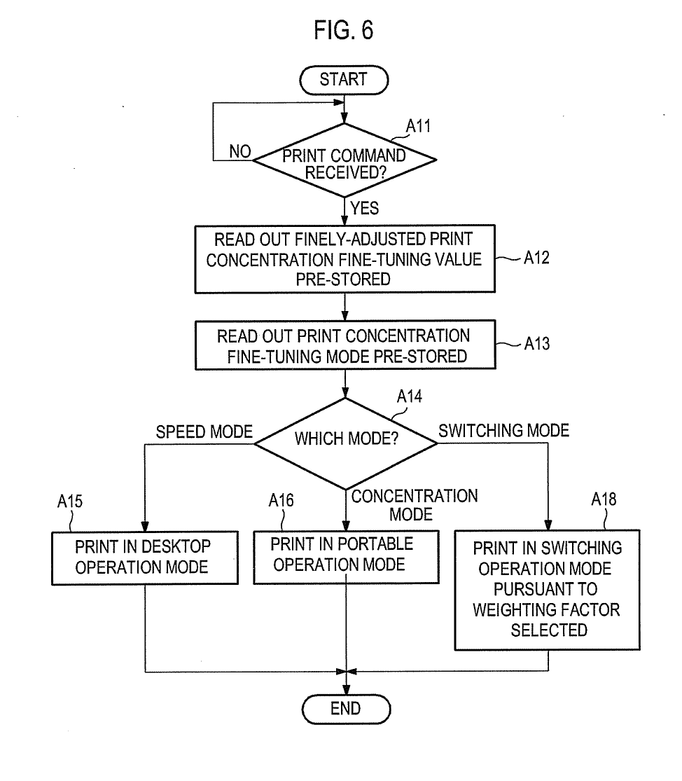

Next, a print process performed in the label printing device 1 configured as above will be described in detail with reference to the flowcharts in FIGS. 3 and 6. FIG. 3 is a flowchart illustrating one example of the print process performed by the label printing device. FIG. 4 is an explanatory view illustrating an operation mode selection screen of the personal computer 3 connected to the label printing device 1. FIG. 5 is an explanatory view illustrating a factor selection screen of the personal computer 3 connected to the label printing device 1. FIG. 6 is a flowchart illustrating another example of the print process performed by the label printing device 1.

As shown in FIG. 1, the label printing device 1, as an issuing system, according to the present embodiment, prints a label, which may be initiated by, e.g., the personal computer 3, which delivers an issuance command to the label printing device 1. In one embodiment, first, the label printing device 1 under the control of the CPU 11 monitors whether print data indication signals are inputted from a communication unit 31 of the personal computer 3 through the communication unit 28. Upon receiving the print data indication signals including information on a format number, modification data and a label issuance request, the print command analyzing unit 26 under the control of the CPU 11 specifies one of the pre-registered label image formats in conformity with the format number and changes the specified label image format pursuant to the modification data. Then, the image rendering unit 27 generates an image according to the format specified and changed by the print command analyzing unit 26. Under the control of the CPU 11, the head control circuit 20 controls the thermal head 21 to print a label using the image generated by the image rendering unit 27.

In the print process set forth above, the label printing device 1 performs the print process in, for example, one of three print concentration fine-turning modes, namely a “desktop operation mode,” “portable operation mode,” and “switching operation mode.” The desktop operation mode (or speed mode) refers to an operation mode in which the intensity of the pulses applied to the thermal head 21 may be changed pursuant to a print concentration fine-tuning value while keeping the print speed constant. The portable operation mode (or concentration mode) refers to an operation mode in which the period of the applied pulses may be changed pursuant to the print concentration fine-turning value and the print speed is set based on the applied pulses. The switching operation mode (or switching mode) refers to an operation mode in which the operation mode may be switched, on a case-by-case basis, to one of the desktop operation mode and the portable operation mode, pursuant to the applied pulses set according to the print concentration fine-turning value and a preset print speed.

Next, the respective operation modes will be described in detail using the flowcharts shown in FIGS. 3 and 6 and the selection screens of the personal computer 3 shown in FIGS. 4 and 5.

The CPU 11 of the label printing device 1 receives a print command from the communication unit 31 of the personal computer 3 through the communication unit 28 or detects a print command corresponding to a printing operation inputted from the key input unit 19 as an operation unit (Act A11). The CPU 11 of the label printing device 1 reads out a print concentration fine-turning value, which may be set by a user through the use of the key input unit 19 as an operation unit, set through an input screen generated by a mode setting application unit 32 of the personal computer 3, or pre-stored in the RAM 13 (Act A12). Similarly, the CPU 11 reads out a print concentration fine-turning mode, which may be set by a user through the use of the key input unit 19 as an operation unit, set through a setting screen generated by the mode setting application unit 32 of the personal computer 3, as shown in FIG. 4, or pre-stored in the RAM 13 (Act A13). Further, the key input unit 19, the mode setting application unit 32 of the personal computer 3 and the RAM 13 as setting units may be used for setting a print speed and a print concentration, which may be supplied to the control unit, CPU 11.

If it is determined that the print concentration fine-tuning mode thus read out is the desktop operation mode (or speed mode) in Act A14, the CPU 11 changes the applied pulses pursuant to the print concentration fine-tuning value while keeping the pre-set print speed constant, to control the image rendering unit 27 to render an image (Act A15). If it is determined that the print concentration fine-tuning mode thus read out is the portable operation mode (or concentration mode) in Act A14, the CPU 11 changes the period of the applied pulses pursuant to the print concentration fine-turning value, sets a print speed based on the applied pulses and causes the image rendering unit 27 to render an image (Act A16).

If it is determined that the print concentration fine-tuning mode thus read out is the switching operation mode (or switching mode) in Act A14, the CPU 11 switches the operation mode automatically (or on a case-by-case basis) to one of the desktop operation mode and the portable operation mode, pursuant to the applied pulses calculated using a pre-set print speed and the print concentration fine-turning value, and causes the image rendering unit 27 to render an image in the switched operation mode (Act A17).

When selecting one of the desktop operation mode and the portable operation mode, the CPU 11 compares the period of the applied pulses calculated using the pre-set print speed and the print concentration fine-tuning value with a threshold value and determines the operation mode according to the comparison result.

In one embodiment, in the process of calculating the period of the applied pulses and comparing the period of the applied pulses with the threshold value, as in Act A18 of the flowchart shown in FIG. 6, a weighting factor is selected by a user through a setting screen generated by the mode setting application unit 32 of the personal computer 3, as shown in FIG. 5, and the operation mode may be selected based on the weighting factor as one of the printing conditions (e.g., residual battery life, power consumption and body unit temperature).

More specifically, if the user selects “residual battery life” on the setting screen shown in FIG. 5, through the mode setting application unit 32 of the personal computer 3, one of the desktop operation mode and the portable operation mode is selected depending on the residual charge amount of the battery 23 shown in FIG. 1. If the user selects “power consumption” on the setting screen shown in FIG. 5, through the mode setting application unit 32 of the personal computer 3, one of the desktop operation mode and the portable operation mode is selected depending on the amount of power consumption of the print process performed according to the print command. If the user designates “temperature” on the setting screen shown in FIG. 5, through the mode setting application unit 32 of the personal computer 3, one of the desktop operation mode and the portable operation mode is selected depending on the body unit temperature measured by the temperature measuring unit 16 shown in FIG. 1. Although only one of the printing conditions is selected in the above embodiment, two or more of these printing conditions may be designated at the same time.

In the label printing device 1 described above, if the user wishes to keep the print speed constant, the user may select “desktop operation mode” (in which the print speed is kept constant) on the setting screen shown in FIG. 4. On the other hand, if the user wishes to keep the print concentration constant, the user may select “portable operation mode” (in which the print concentration is kept constant) on the setting screen shown in FIG. 4. Otherwise, if the user decides to set the two modes to be switchable pursuant to the printing conditions (e.g., residual battery life, power consumption, temperature, etc.), the user may select “switching operation mode” on the setting screen shown in FIG. 4. Further, if the user wishes to specify a weighting factor for the mode selection, the user may designate one or more of “residual battery life,” “power consumption” and “temperature” on the setting screen shown in FIG. 5. In some embodiments, the setting screen as shown in FIG. 5 may display some additional weighting factors such as “printing speed” and “printing quality.” In such case, if the user selects “printing speed” as a weighting factor, the print concentration fine-tuning mode may be switched to the desktop operation mode, in which the printing speed can be maintained to be constant regardless of a variation in the printing quality. Otherwise, if the user selects “printing quality” as a weighting factor, the print concentration fine-turning mode may be switched to the portable operation mode, in which the printing quality (i.e., print concentration) can be maintained to be constant regardless of a variation in the printing speed.

According to the above embodiment, even in the label printing device 1 having a built-in rechargeable battery, it is possible to perform printing by selectively maintaining high printing quality or high printing throughput, depending on the user's settings. It is also possible to adjust the priority of weighting factors such as battery power, power consumption or body unit temperature, depending on the user's intentions.

As used in this application, entities for executing the actions can refer to a computer-related entity, either hardware, a combination of hardware and software, software, or software in execution. For example, an entity for executing an action can be, but is not limited to, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in an apparatus, can be downloaded through a network to the apparatus, or can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus

While certain embodiments have been described, these embodiments have been presented by way of example only, and are not intended to limit the scope of the inventions. Indeed, the novel label printing device and label printing method described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A label printing device, comprising:
an image rendering unit configured to render a label image on a recording medium; and
a control unit configured to control the image rendering unit to render the label in one of a first operation mode, in which printing is performed while keeping a print speed constant, and a second operation mode, in which printing is performed while keeping a print concentration constant.

2. The device of claim 1, wherein the control unit is configured to set the operation mode to a third operation mode, in which the third operation mode is switchable to one of the first and second operation modes pursuant to at least one of a print speed and a print concentration set by a setting unit.

3. The device of claim 1, wherein the control unit is configured to determine the operation mode if the control unit receives a print command from an external device.

4. The device of claim 1, further comprising a rechargeable battery configured to supply electric power to the image rendering unit and the control unit.

5. The device of claim 4, wherein the control unit is configured to, if at least one weighting factor is designated by an external device, switch the operation mode to one of the first and second operation modes pursuant to the designated factor.

6. The device of claim 5, wherein the weighting factor includes at least one of a residual charge amount of the rechargeable battery, power consumption of the rechargeable battery, printing speed, printing quality, and a temperature in the label printing device detected by a temperature measuring unit.

7. A label printing method in a label printing device, the method comprising:
setting, by a control unit, an operation mode to one of a first operation mode, in which printing is performed while keeping a print speed constant, and a second operation mode, in which printing is performed while keeping a print concentration constant; and
rendering, by an image rendering unit, a label image on a recording medium in the selected mode.

8. The method of claim 7, further comprising setting, by the control unit, the operation mode to a third operation mode, in which the third operation mode is switchable to one of the first and second operation modes depending on the print speed and the print concentration.

9. The method of claim 7, wherein setting the operation mode includes setting, by the control unit, the operation mode to one of the first and second operation modes, if at least one weighting factor is designated, pursuant to the designated factor.

10. The method of claim 9, wherein the weighting factor include at least one of a residual charge amount of a rechargeable battery, power consumption of the rechargeable battery, printing speed, printing quality, and a temperature in the label printing device detected by a temperature measuring unit.
